(19) United States
(12) Patent Application Publication
(10) Pub. No.: US 2026/0323596 A1
(43) Pub. Date: Oct. 15, 2026

(54) METHODS AND APPARATUSES FOR PAGING IN COMMUNICATION SYSTEMS

(71) Applicant: TOYOTA JIDOSHA KABUSHIKI KAISHA, Toyota-shi (JP)

(72) Inventors: Kai-Erik SUNELL, Naantali (FI); Takayuki SHIMIZU, Mountain View, CA (US); Claude ARZELIER, Varna (BG); Onur ALTINTAS, Mountain View, CA (US); John KENNEY, Mountain View, CA (US)

(73) Assignee: TOYOTA JIDOSHA KABUSHIKI KAISHA, Toyota-shi (JP)

(21) Appl. No.: 19/695,827

(22) Filed: Jun. 2, 2026

Related U.S. Application Data
(63) Continuation of application No. PCT/JP2025/008509, filed on Mar. 7, 2025.
(60) Provisional application No. 63/563,285, filed on Mar. 8, 2024.

(51) Int. Cl. H04W 68/02; H04W 74/0808; H04W 92/18

(52) U.S. Cl. CPC H04W 68/02; H04W 74/0808; H04W 92/18

(57) ABSTRACT

Disclosed are methods, apparatuses, and systems for relaying paging information in a communication. One of the methods includes receiving, from a base station, paging information for the third UE.

### CROSS-REFERENCE TO RELATED PATENT APPLICATION

This application claims the benefit of U.S. Provisional Application No. 63/563,285, filed on Mar. 8, 2024, entitled “METHODS AND APPARATUSES FOR PAGING IN COMMUNICATION SYSTEMS,” he entirety of which is incorporated by reference herein.

### FIELD

Apparatuses and methods consistent with the present disclosure relate generally to communications, more specifically, methods, systems, and devices for paging relaying in communications.

### BACKGROUND

One of fundamental characteristics of modern telecommunication services, including radio communication services, is the unpredictable nature of traffic arrival. A paging message may be sent to a mobile node, such as a portable device, to notify it of an incoming call or data, prompting the node to wake up from idle mode and prepare for reception. However, the mobile nature of these nodes complicates the network's ability to determine the precise location for paging a specific node. Paging a node over a large area also demands significant communication resources from the network, including spectrum resources. Additionally, for portable devices, listening to paging messages is energy consuming, which can quickly deplete battery resources of portable devices. Therefore, a challenge lies in efficiently locating a specific node and delivering paging messages while minimizing energy and resource consumption. Systems and methods that can effectively deliver paging messages to specific nodes in an energy-efficient and resource-efficient manner are desired.

### Summary

According to some embodiments of the present disclosure, there is provided a method for a second node for relaying paging information in a communication. The method includes receiving, from a first node, the paging information, the paging information informing one or more third nodes of an incoming call or data, and comprising at least one of: one or more paging messages, or one or more pre-paging notifications; embedding the paging information in one or more data units; and transmitting the one or more data units to the one or more third nodes.

According to some embodiments of the present disclosure, there is provided a method for a third node for receiving paging information in a communication. The method includes: determining a quality of one or more signals received from a first node; and in response to a determination that the quality of the one or more signals is lower than a threshold, initiating reception of one or more data units transmitted from a second node, wherein the one or more data units transmitted from the second node includes embedded paging information that is originated from the first node and directed to the third node, the paging information comprising at least one of: one or more paging messages, or one or more pre-paging notifications.

According to some embodiments of the present disclosure, there is provided a second node for relaying paging information in a communication. The second node includes a memory storing an instruction; and a processor configured to execute the instruction stored in the memory to: receive, from a first node, the paging information, the paging information informing one or more third nodes of an incoming call or data, and comprising at least one of: one or more paging messages, or one or more pre-paging notifications; embed the paging information in one or more data units; and transmit the one or more data units to the one or more third nodes.

According to some embodiments of the present disclosure, there is provided a third node for receiving paging information in a communication. The third node includes a memory storing an instruction; and a processor configured to execute the instruction stored in the memory to: determine a quality of one or more signals received from a first node; and in response to a determination that the quality of the one or more signals is lower than a threshold, initiate reception of one or more data units transmitted from a second node, wherein the one or more data units transmitted from the second node includes embedded paging information that is originated from the first node and directed to the third node, the paging information comprising at least one of: one or more paging messages, or one or more pre-paging notifications.

According to some embodiments of the present disclosure, there is provided a non-transitory computer-readable medium storing instructions that are executable by one or more processors of a second node for relaying paging information, to perform a method. The method includes receiving, from a first node, the paging information, the paging information informing one or more third nodes of an incoming call or data, and comprising at least one of: one or more paging messages, or one or more pre-paging notifications; embedding the paging information in one or more data units; and transmitting the one or more data units to the one or more third nodes.

According to some embodiments of the present disclosure, there is provided a non-transitory computer-readable medium storing instructions that are executable by one or more processors of a third node for receiving paging information, to perform a method. The method includes determining a quality of one or more signals received from a first node; and in response to a determination that the quality of the one or more signals is lower than a threshold, initiating reception of one or more data units transmitted from a second node, wherein the one or more data units transmitted from the second node includes embedded paging information that is originated from the first node and directed to the third node, the paging information comprising at least one of: one or more paging messages, or one or more pre-paging notifications.

### BRIEF DESCRIPTION OF DRAWINGS

FIG. 1 is a schematic diagram illustrating relaying paging information via a sidelink communication, consistent with some embodiments of the present disclosure.

FIG. 2 is a schematic diagram illustrating relaying paging information via a sidelink communication, consistent with some embodiments of the present disclosure.

FIG. 3 is a schematic diagram illustrating relaying paging information via a sidelink communication, consistent with some embodiments of the present disclosure.

FIG. 4 is a schematic diagram illustrating relaying paging information via a sidelink communication, consistent with some embodiments of the present disclosure.

FIG. 5 is a schematic diagram illustrating relaying paging information via a sidelink communication, consistent with some embodiments of the present disclosure.

FIG. 6 is a schematic diagram illustrating a method for a second node for relaying paging information in a communication, consistent with some embodiments of the present disclosure.

FIG. 7 is a schematic diagram illustrating a method for a third node for receiving paging information in a communication, consistent with some embodiments of the present disclosure.

FIG. 8 is a block diagram of a node, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

In the present disclosure, the term “node” s used as a general term that includes, but is not limited to, user equipment (UE), one or more relay nodes, one or more vehicle mounted modules, and one or more network infrastructure nodes such as base stations (e.g., eNB, gNB), roadside units, repeaters, transponders, wireless routers, controllers, access points, and sub-systems thereof. In this disclosure, the terms “radio system” and “radio interface” re used as general terms which include, but are not limited to, terrestrial and satellite systems.

One of fundamental characteristics of modern telecommunication services, such as radio communication services, is the arrival of traffic at unpredictable instants of time. Therefore, an integral function of radio communication networks is a one-way transmission of a message to inform a node, such as a portable mobile device, of an incoming call or data. The function is generally referred to as paging. A paging message typically conveys the identity of the destination node. Upon reception of a paging message, where the identity matches with that of the node, the receiving node requests for a connection setup with the network and subsequently sends a response to the paging message to indicate readiness for the reception of the incoming call or data.

In mobile radio communication systems, such as terrestrial and non-terrestrial networks, the geographical location of arrivals are normally unknown in advance prior to paging which creates additional challenges. This is because typically idle nodes, e.g., a mobile node without an ongoing connection with the network, are paged. The mobile nature of the idle nodes makes it difficult for the network to know where a specific node needs to be paged. In addition, listening to paging messages is energy consuming for a portable idle node, such as handheld user equipment, thus draining their battery resources. Similarly, paging of a node within a large area requires a lot of communication resources at the network side, such as spectrum resources. Therefore, the problem essentially boils down to finding a specific node within the entire coverage area of the network in an energy and resource efficient manner.

Standardized radio interfaces address the problem by specifying paging occasions and registration and/or paging areas. A paging occasion described in the present disclosure may include a time and/or frequency resource where a paging message can be transferred. Nodes have paging occasions that are derived from their unique identity associated with timing and/or synchronization information shared with both sides of the interface. The paging occasions are further very short to facilitate paging of large population of nodes. They are repeated at a regular interval whereof the node's radio circuits can be switched on for the reception of a potential paging message, and otherwise switched off to save battery resources. In turn, the registration and/or paging areas are sub-areas of the network coverage area, and the mobile node may report to the network its movements between these areas. Examples of such sub-areas can be a set of cells, individual cells, sectors of cells, and antenna beams.

The network normally starts paging within a sub-area where the node has shown latest interaction with the network. If the node does not respond to the first paging attempt, e.g., in a case that the node does not reside in the sub-area where it is paged, the subsequent paging attempts may be resent by gradually increasing the (sub-)area until the node responds.

A problem arises since the transfer of a paging message may be adversely impacted by insufficient link margin. It may happen when a user has placed a portable node in a place where reception is severely impaired, e.g., in a pocket, backpack, or vehicle, or when there is another blockage. Paging attempts may be expected to fail even if the network performs multiple attempts within a gradually increased area. Therefore, the 3rd Generation Partnership Project (3GPP) has identified the need for a robust paging feature to increase paging reliability. This is especially important in non-terrestrial networks. The main requirements for the 3GPP robust paging feature are that it should be triggered by the network upon paging failures, e.g., when no paging response from the destination node has been received by the network, and it should inform the end-user of an incoming call or data to trigger movement of the node to a location with better coverage.

A robust paging approach is attempted in a non-terrestrial or satellite communication system. If a call from one satellite customer to another is not answered on the first attempt, the satellite network boosts power during an automatic second attempt. In some examples, a satellite can concentrate considerable percentage of the total power into a single beam. As opposed to this type of satellite system architectures, standardized radio system architectures are specified for multi-vendor environments. Consequently, they make use of a functional split between access stratum and non-access stratum. The access stratum is used for transporting data over the radio interface and managing radio resources whereas the non-access stratum is used for managing the establishment of communication sessions and for maintaining continuous communications with a portable node as it moves. It follows that the access stratum is not aware of missed or failed paging occasions and likewise the non-access stratum does not know why paging failed because non-access stratum is lacking radio awareness. Therefore, the power boosting solution may not be applicable for standardized multi-vendor radio system architectures, such as in 3GPP standards.

There may be techniques for improving coverage and information transfer reliability and the techniques may be discussed for paging messages. 3GPP radio interfaces specify techniques for repetitions and combining in the context of Internet of Things (IoT) features. This is generally termed as Narrow Band IoT (NB-IoT). In such an approach, a message or data is repeated multiple times at the sender side and soft-combined at the receiver side to accumulate received signal energy. If the technology from NB-IoT is used for paging, the access stratum repeats the transmission of a paging message, i.e., a paging occasion is composed of multiple transmissions. If the receiver side manages to successfully decode the paging message, it sends a response message to the non-access stratum. The technique is however impractical because it would lead to an excessive number of repetitions. If the link gain compensation is in the order of 20 dB, which may be desired for the robust paging feature, it would require up to 100 repetitions. It would consume a considerable part of the paging resource and therefore the technique may be ruled out because of its inefficiency.

It has also been proposed to use a pre-paging notification message which is sent prior to the paging message. The purpose of the notification is to make the node move to another position where coverage is better. The intention of a pre-paging message is not to trigger a response message but upon successful reception of the paging message in a better coverage condition, the node can send a response to the non-access stratum. A further improvement to the pre-paging is an excessively enhanced paging notification channel. The enhancements are based on repetition in a similar manner as in the NB-IoT but the impact on paging capacity is likely to be less resource demanding. But still, it suffers from adverse impact on the already limited paging capacity.

Yet another proposal is to require support of NB-IoT in smart phones or other mobile nodes and send a Short Message Service (SMS) data notification from a non-access stratum server to the destination node over NB-IoT, as discussed in 3GPP. In such an approach, another type of radio interface and/or system is used for the transfer paging information on behalf of another system. But this may require coordination between different networks and may cause paging collisions within different networks.

At least some embodiments of the present disclosure provide solutions to the above-noted issues by relaying paging messages and/or pre-paging notifications. At least some embodiments of the present disclosure use sidelink, for example, direct communication between mobile nodes without fixed network infrastructure, for relaying paging messages from terrestrial and non-terrestrial networks for the sake of robust paging. In some embodiments, sidelink is used for sharing information among vehicles and between vehicles and other entities (e.g., road-side units, pedestrians, cyclists), for example, periodically or aperiodically. Sidelink may not support any paging function because it does not handle tele-traffic with randomly incoming calls or data, and it is lacking call setup and call routing functions. Therefore, a paging message or pre-paging notification can be embedded in sidelink protocols, for example, by piggybacking the paging message or pre-paging notification on sidelink messages, such as in broadcasted data, and in that way, it can be shared with a population of nodes, for example, inside or within the proximity of a vehicle. Upon detected coverage holes or impaired link margin, the node can listen to sidelink information transfer and thereby obtain the paging message or pre-paging notification from sidelink.

In the present disclosure, the term “embed” or “embedding”) is used as a general term of incorporating, including, or attaching one message-whether it be signal(s), data, data packet(s), notification(s), or bit(s)-within another message or to another message through any methods, including piggybacking.

In some embodiments of the present disclosure, relaying of paging information via sidelink is radio-aware and based on local decisions, such as channel sensing and radio measurements, in a relaying node and the decisions are issued without interactions to a controlling entity at a network side that sends or triggers a transmission of paging information. A decision on whether and how to relay a paging message is issued autonomously in a relying sidelink entity as opposed to transmission requests from an originating network. The paging information is further relayed without mapping to a unique paging occasion because paging information can be embedded in sidelink protocol data units or application data. In other words, relayed paging information and its instant of transmission are determined by sidelink protocol or application behavior, for example, transmission periodicity, as opposed to a unique paging occasion which is based on destination node's identity. Consequently, paging information can be relayed without any inspection of paging information content and without knowledge about a destination node's identity. Due to the absence of sidelink paging function and unique paging occasions, a relaying entity can embed simultaneously multiple paging messages within a single sidelink data unit.

At least some embodiments of the present disclosure ensure enhanced paging robustness and reliability without: (1) impacting the paging capacity adversely because the paging message is relayed on sidelink spectrum resources, (2) changing existing radio system architectures and their functional split between access stratum and non-access stratum because the solution neither requires monitoring of paging failures at the access stratum nor radio-awareness at the non-access stratum, (3) inspecting the content of paging information, (4) knowing an identity of a destination node, and (5) receiving requests or control information from a network entity that is triggering or sending paging information.

Although some embodiments described in the present disclosure are exemplified with relaying paging information via sidelink communications, the scope of the present disclosure is not so limited. The methods described in the present disclosure can be applied in transferring any information, in any communication systems, including, but not limited to, terrestrial and non-terrestrial mobile radio communication systems.

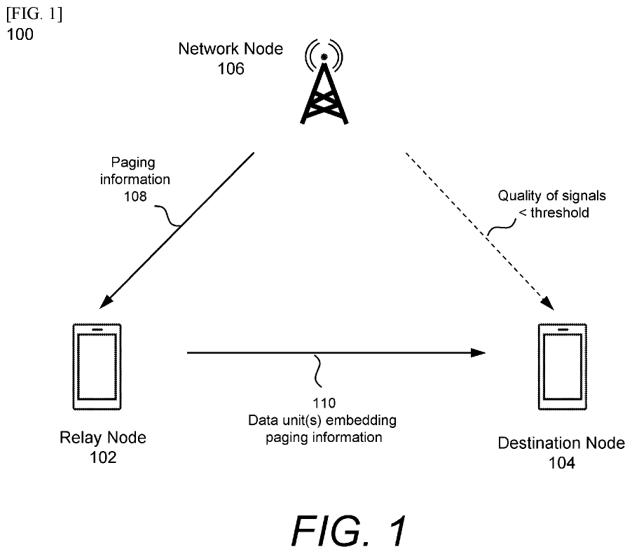

FIG. 1 is a schematic diagram illustrating a scheme for relaying paging information via a sidelink communication, consistent with some embodiments of the present disclosure. Referring to FIG. 1, a communication system 100 includes a node 102, a node 104, and a node 106. The term “node” escribed in the present disclosure refers to a general term that includes, but is not limited to, user equipment (UE), one or more relay nodes, one or more vehicle mounted modules, and one or more network infrastructure nodes such as base stations, core networks, roadside units, repeaters, transponders, wireless routers, controllers, access points, and sub-systems thereof. The node 102 and the node 104 may be two UEs in a sidelink communication, for example, two portable mobile devices communicating via sidelink. The node 106 may be a base station (e.g., eNB, gNB), a core network that connected with a base station, or a network node including both a base station and a core network. The base station may be any base station currently existing, such as base stations for long term evolution (LTE) or new radio (NR), or base stations for a future generation (6^{th} generation (6G), 7^{th} generation (7G), or any other future generation) radio access technology (RAT). The node 102 and the node 104 may communicate with each other using sidelink signals via a PC5 radio interface. For example, the node 102 may transmit a physical sidelink control channel (PSCCH) and/or physical sidelink shared channel (PSSCH) to the node 104, and in response, the node 104 may or may not transmit a feedback signal, such as physical sidelink feedback channel (PSFCH) to the node 102. The node 102 and/or the node 104 may also communicate with one or more other nodes (not shown) in the sidelink communication.

In some embodiments, the node 106 sends paging information directed to a destination node—the node 104, informing the node 104 of an incoming call or data. The paging information can be, for example, a paging message or a pre-paging notification transferred, for example, on a unique paging occasion determined from the identity of the destination node (node 104) or a data notification message sent by another network node on behalf of the node 106.

In some cases, the paging information transmitted from the node 106 may not be received by the node 104 because the quality of the signals is lower than a threshold. This may be the case when, for example, the node 104 is placed in a pocket, backpack, or vehicle of the user of the node. Instead, the paging information 108 transmitted from the node 106 is received by the node 102. Upon reception of the paging information, the node 102 performs the function of a relay node. For example, the node 102 may embed the received paging information 108 in one or more data units 110 and transmit the data units to the destination node 104 over sidelink. In this way, the node 104 can receive the paging information addressed to it through the relay node 102 via sidelink communication, even if the communication link between the node 104 and the network node 106 is impaired.

The one or more data units 110 transmitted to the node 104 may include at least one of: one or more application-level messages, one or more sidelink system information messages or blocks, one or more radio protocol data units, one or more radio protocol headers, one or more radio protocol control elements, physical layer control information, one or more physical layer fields, one or more synchronization frames, or one or more physical layer symbols. The one or more application-level messages may include at least one of: a periodically generated application-level message or an event-triggered application-level message. For example, the one or more application-level messages may include at least one of: a vehicle-to-everything (V2X) basic safety message (BSM), a decentralized environmental notification message (DENM), or a cooperative awareness message (CAM). The one or more sidelink system information messages or blocks may include one or more sidelink master information blocks. The one or more radio protocol data units may include at least one of: one or more radio link controls (RLCs), one or more packet data convergence protocols (PDCPs), or one or more service data adaptation protocols (SDAPs). The one or more radio protocol control elements may include one or more medium access control (MAC) protocol control elements (CEs). The physical layer control information may include sidelink control information (SCI).

In some embodiments, the one or more data units 110 may include one or more first type data units and one or more second type data units, and the paging information may include one or more paging messages, and one or more pre-paging notifications. In this case, the one or more paging messages may be embedded in the one or more first type data units, and the one or more pre-paging notifications may be embedded in the one or more second type data units.

In some embodiments, the node 102 may receive from the node 106 paging information directed to multiple sidelink nodes (not shown) in multiple paging occasions. The node 102 may embed the paging information directed to multiple sidelink nodes in one or more data units, and transmit the one or more data units to the destination nodes.

The node 104 may also actively monitor the quality of signals received from the node 106 to determine whether to initiate reception of sidelink signals from another sidelink node (e.g., the node 102) that is relaying paging information. In response to a determination that the quality of one or more signals received from the node 106 is lower than a threshold, the node 104 may initiate reception of sidelink signals from the node 102. The threshold may be configured by the network node 106, pre-configured at the node 104, or predefined. The quality of the one or more signals that the node 104 monitors may include at least one of: a reference signal received power (RSRP), a reference signal received quality (RSRQ), signal to noise ratio (SNR), or a signal to interreference-plus noise ratio (SINR). In the present disclosure, the terms “signal”, “data”, “data unit”, and “message” re used interchangeably. For example, reception of a signal from a node may also indicate reception of a data unit from the node.

In some embodiments, the node 104 may receive the sidelink signals from the node 102 using a three-step method as described below. In a first step, the node 104 determines quality of one or more signals received from the node 106, and in response to a determination that the quality of the one or more signals is lower than the threshold, the node 104 starts a first timer t1. In a second step, the node 104 determines whether the first timer t1 is running upon a paging occasion, and in response to a determination that the first timer t1 is running upon a paging occasion, the node 104 starts a second timer t2. In a third step, the node 104 determines whether the second timer is running upon a paging occasion, and in response to a determination that the second timer t2 is running on a paging occasion, the node 104 initiates reception of the one or more data units transmitted from the node 102 via sidelink. Additionally, if the node 104 finds relayed paging information that is directed to the node 104 in the one or more data units transmitted from the node 102, the node 104 resets both timers to zero. Further, if the node 104 determines that the second timer is expired, the node 104 may wait for a next paging occasion.

In some embodiments, in order to determine whether to transmit the one or more data units 110 to the node 104, the node 102 may perform a sensing on one or more sidelink radio resources to obtain information about activities of one or more other sidelink nodes in vicinity (not shown). The one or more sidelink radio resources may include one or more channel busy ratios and/or one or more received signal powers of the sidelink signals. Based on a sensing result of the sidelink radio resources, the node 102 may determine whether to transmit the one or more data units 110 to the node 104. For example, in some embodiments, in response to a determination that the sensing result indicates a higher activity of the one or more other sidelink nodes in vicinity and a channel busy ratio is smaller than a threshold value, the node 102 may transmit the one or more data units 110 to the node 104. In some embodiments, in response to a determination that the sensing result indicates lower activity of the one or more other sidelink nodes in vicinity and the channel busy ratio is greater than the threshold value, the node 102 may transmit the one or more data units 110 to the node 104. The threshold for the channel busy ratio may be configured by the network node 106, pre-configured at the node 102, or predefined. In some embodiments, in response to a determination that the sensing result indicates absence of other sidelink nodes in the proximity or an existence of a traffic congestion in the proximity, the node 102 may determine not to transmit the one or more data units 110 to the node 104.

In some embodiments, the node 102 may be a device mounted in a vehicle, and the node 104 may include one or more portable devices disposed inside the vehicle. The paging information may include an identification (ID) of at least one destination node. In this case, the node 102 may receive, via the one or more portable devices, an ID of at least one of the one or more portable devices and compare the ID included in the paging information with the ID of the at least one of the one or more portable devices. In response to a determination that the ID included in the paging information matches with the ID of the at least one of the one or more portable devices, the node 102 may transmit the one or more data units to the at least one of the one or more portable devices.

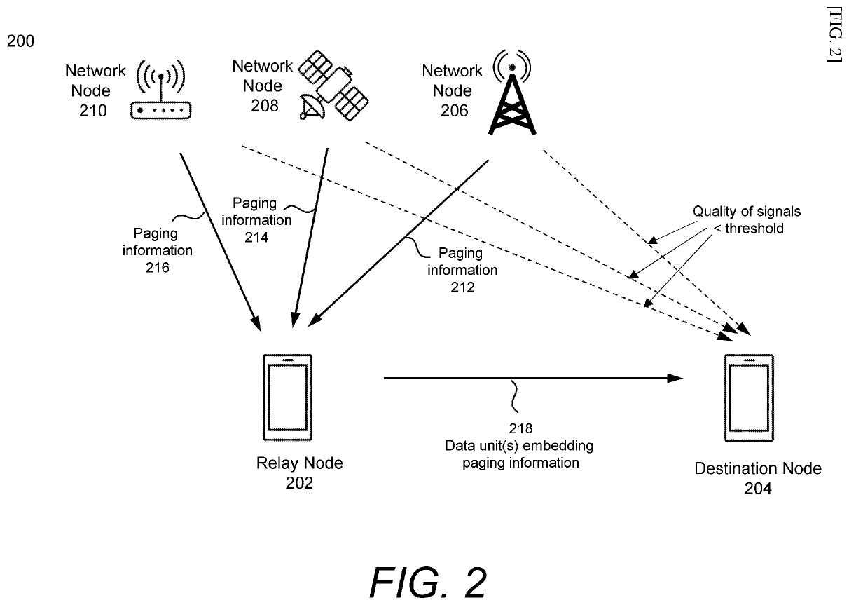

FIG. 2 is a schematic diagram illustrating a scheme for relaying paging information via a sidelink communication, consistent with some embodiments of the present disclosure. Referring to FIG. 2, a communication system includes a node 202, a node 204, a node 206, a node 208, and a node 210. The node 202, the node 204, and the node 206 are similar to the node 102, the node 104, and the node 106 of FIG. 1, respectively. For the sake of simplicity, the details of the node 202, the node 204, and the node 206 are omitted here. Compared with FIG. 1, in FIG. 2, a plurality of network nodes transmits paging information directed to the node 204. In particular, in addition to the node 206, the exemplary arrangement of FIG. 2 also includes an additional network node 208 (e.g., a non-terrestrial network node) and an additional network node 210 (e.g., a road side unit). As in the case in FIG. 1, in FIG. 2, the destination node (the node 204) may not directly receive paging information from any of the network nodes, while the relay node (the node 202) receives the paging information directed to the node 204 from each of the network nodes. For example, as shown in FIG. 2, the relay node 202 receives the paging information 212 transmitted from the network node 206, the paging information 214 transmitted from the network node 208, and the paging information 216 transmitted from the network node 210. In this case, the node 202 may store (locally or remotely) the paging information from the network nodes (206, 208, and 210) and combine the paging information (212, 214, and 216) from the different network nodes to increase reception reliability. The node 202 may further embed the combined paging information in one or more data units 218 and transmit the one or more data units to the destination node 204. In this way, the node 204 may successfully receive paging information directed to it even if all the direct links between the node 204 and the network nodes are impaired.

In some embodiments, in combining the paging information, the node 202 may make use of reliability information or SINR estimates to select the most reliable paging information and discard the least reliable paging information. For example, the node 202 may compare the SINR values corresponding to the different paging information (212, 214, and 216), and based on SINR comparison, determine the most reliable paging information and the least reliable paging information. For example, the paging information 216 received from the network node 210 may be the least reliable information because it has the lowest corresponding SINR value, while the paging information 212 received from the network node 206 may be the most reliable information because it has the highest corresponding SINR value. In this case, the node 202 may discard the paging information 216 and use the combination of the paging information 212 and the paging information 214, or discard the paging information 216 and the paging information 214, and use the paging information 212 only.

In some embodiments, the node 202 may combine the paging information by accumulating the signal energy of the signals received from the different network nodes by using soft-combining, for example, by weighting the soft-bits with reliability information in conjunction with soft-combining. In some embodiments, the node 202 may combine paging information from multiple transmissions received from the same network node. For example, the node 202 may receive multiple transmissions of paging information directed to the node 204 from the node 206, and combine the received multiple transmissions to improve reception reliability.

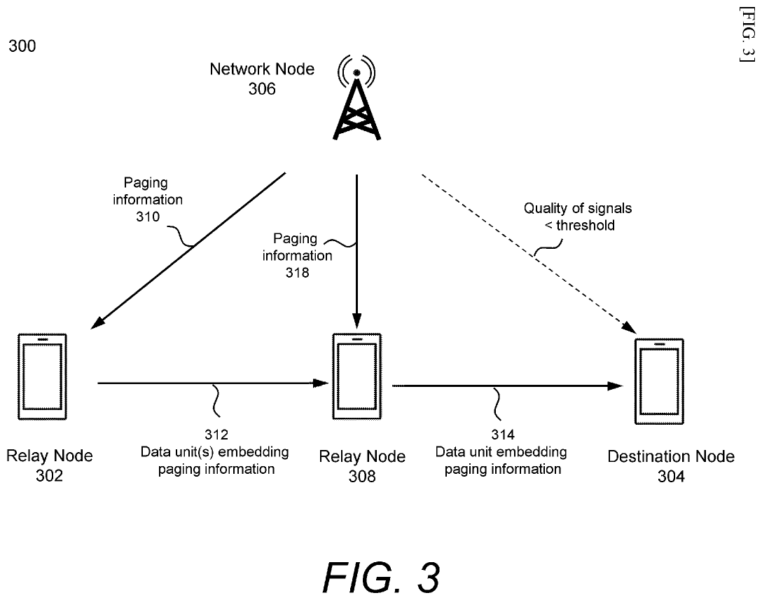

FIG. 3 is a schematic diagram illustrating a scheme for relaying paging information via a sidelink communication, consistent with some embodiments of the present disclosure. Referring to FIG. 3, a communication system 300 includes a node 302, a node 304, a node 306, and a node 308. The nodes 302, 304, and 306 are similar to the nodes 102, 104, and 106 of FIG. 1, respectively. For the sake of simplicity, the details of the nodes 302, 304, and 306 are omitted here. Compared with FIG. 1, in FIG. 3, the node 302 (a relay node) relays the paging information 310 received from the network node 306 to another relay node (the node 308), rather than relaying it directly to the destination node (the node 304). For example, upon reception of the paging information 310 from the network node 306, the node 302 may embed the paging information in one or more data units 312, and transmit it to the node 308. This may be the case, for example, because the sidelink connection between the node 302 and the node 304 is impaired. The node 308 then takes a role of a relay node, and relays the paging information embedded in the one or more data units 312 to the destination node (the node 304). For example, the node 308 may extract the paging information from the one or more data units 312, embed the paging information in one or more data units 314, and transmit the one or more data units 314 to the destination node 304 via sidelink transmission.

On the other hand, the node 308 may also receive paging information 318 directed to the node 304 from the network node 306. In this case, the node 308 may combine the paging information relayed from the node 302 and the paging information 318 received from the network node 306 to improve reception reliability. For example, the node 308 may store paging information 318 received from one or more paging occasions, and combine the stored information with the paging information relayed from the node 302. In some embodiments, the node 308 may combine the paging information by accumulating a received signal energy of transmission of the paging information relayed from the node 302 and a received signal energy of transmission of the paging information received from the network node 306. In some embodiments, the node 308 may combine the paging information by selecting the most reliable paging information between the paging information relayed from the node 302 and the paging information received from the network node 306, and discard the least reliable information. The node 308 may determine the most reliable paging information and the least reliable paging information by comparing the SINR values corresponding to the paging information.

In some embodiments, before the paging information is relayed to the destination node 304, the paging information may be relayed by one or more subsequent relay nodes (not shown) after the node 308. In order to prevent flooding in a multi-hop scenario, after receiving the relayed paging information from the node 302, the node 308 may append or associate the relayed paging information with at least one of: a hop counter, a first timestamp indicating a time when relayed paging information is received, a period during which the paging information is considered valid, a second timestamp indicating a time when the paging information becomes invalid, or a geographical position or a zone at which the paging information is generated. For example, the hop counter associated with the paging information may be incremented at every hop where the paging information is relayed from one node to another node.

In some embodiments, the node 308 may determine a time difference between the first timestamp and an internal clock time or an external time source time. The internal clock time may be an instant of time shown on an internal clock disposed within the node 308. The external time source time may be, for example, an instant of time determined using a satellite navigation system (e.g., a GPS) or any other external time source. In response to a determination that the time difference exceeds a conveyed period, the node 308 may discard the paging information and not relay it to any other relay node. The conveyed period may be the same as the period when the paging information is considered valid.

In some embodiments, the node 308 may compare the second time stamp with an internal clock time or an external time source time. The internal clock time may be an instant of time shown on an internal clock within the node 308. The external time source time may be, for example, an instant of time shown on a satellite navigation system (e.g., a GPS) or any other external time source. In response to a determination that the second time stamp is equal to or greater than the internal clock time or the external time source time, the node 308 may discard the paging information.

In some embodiments, the node 308 may calculate a separation distance between its position (e.g., a position obtained from satellite navigation system) and the geographical position or a zone at which the paging information is generated (or transmitted). For example, the node 308 may calculate the separation distance between its position and the network node 306 at which the paging information is transmitted. In response to a determination that the separation distance is equal to or greater than a threshold, the node 308 may discard the paging information. The threshold may be configured by the network node 306, preconfigured at the node 308, or predefined. The above-described procedures for preventing a multi-hop phenomena of paging information between multiple relay nodes can be applied to any relay node, for example, the relay node 302 of FIG. 3 or the relay node 202 of FIG. 2, or the relay node 102 of FIG. 1.

In some embodiments, a set of relay nodes is controlled by a controlling sidelink node to avoid unnecessary flowing of paging information to many directions. For example, in FIG. 3, the node 302 may decide to become a controlling node to control one or more other relay nodes including the node 308. Alternatively, the node 308 may decide to become a controlling node to control one or more other relay nodes including the node 302. The node 302 (or the node 308) may become the controlling node based on a probability of becoming the controlling node. The probability of becoming the controlling node may be determined based on at least one of: one or more radio measurements, a received paging signal energy, a node type, a vehicle type, a charging state of a vehicle, or a movement state of the vehicle.

In some embodiments, in order to determine the probability of becoming the controlling node, the node 302 (or the node 308) may perform one or more radio measurements, and based on the one or more radio measurements, identify a number of neighboring nodes. In this case, the probability of becoming the controlling node increases as the number of identified neighboring nodes increases. The one or more radio measurements performed by the node 302 (or the node 308) may include at least one of: a received signal power or a channel busy radio.

In some embodiments, in order to determine the probability of becoming the controlling node, the node 302 (or the node 308) may determine received paging signal energy from a paging occasion. The probability of becoming the controlling node increases as the received paging signal energy increases.

In some embodiments, the probability of becoming the controlling node depends on a node type of the node 302 (or the node 308). For example, the node type may include one of a vehicle, a vehicle mounted device, or a portable device. In this case, the vehicle or the vehicle mounted device has a higher probability of becoming the controlling node than the portable device.

In some embodiments, the node 302 (or the node 308) may be a vehicle or a device mounted in the vehicle, and the probability of becoming the controlling node depends on a type of the vehicle. For example, the vehicle type may include one of an electrical vehicle, an internal combustion engine vehicle, or a hybrid vehicle. In this case, the internal combustion engine vehicle or a device mounted in the internal combustion engine vehicle has a higher probability of becoming the controlling node than the electric vehicle or a device mounted in the electrical vehicle, and the electric vehicle or the device mounted in the electrical vehicle has a higher probability of becoming the controlling node than the hybrid vehicle or a device mounted in the hybrid vehicle.

In some embodiments, the node 302 (or the node 308) may be a vehicle or a device mounted in the vehicle, and the probability of becoming the controlling node depends on a charging state of the vehicle. For example, a charged vehicle or a device mounted in the charged vehicle has a higher probability of becoming the controlling node than a vehicle in a process of charging or a device mounted in the vehicle in the process of charging, and a vehicle in higher state of charge or a device mounted in the vehicle in higher state of charge has a higher probability of becoming the controlling node than a vehicle in lower state of charge or a device mounted in the vehicle in lower state of charge.

In some embodiments, the node 302 (or the node 308) may be a vehicle or a device mounted in the vehicle, and the probability of becoming the controlling node depends on a movement state (or a speed) of the vehicle. For example, a moving vehicle or a device mounted in the moving vehicle has a higher probability of becoming the controlling node than a parked vehicle or a device mounted in the parked vehicle.

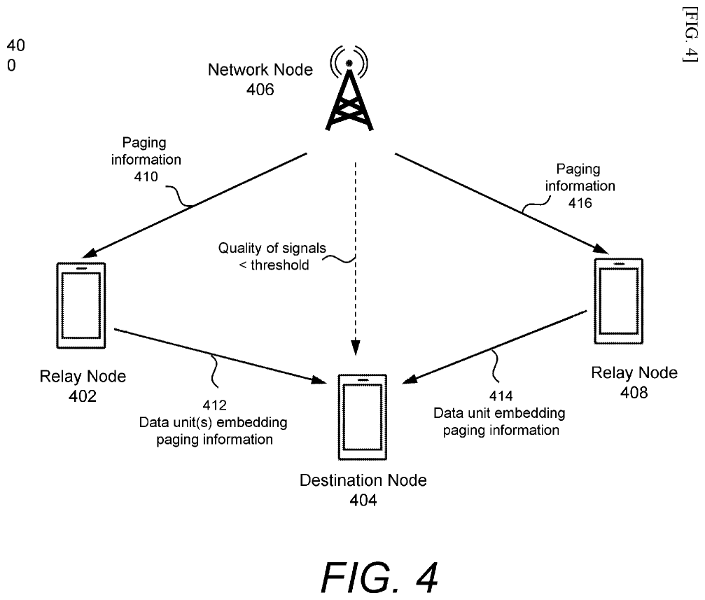

FIG. 4 is a schematic diagram illustrating a scheme for relaying paging information via a sidelink communication, consistent with some embodiments of the present disclosure. Referring to FIG. 4, a communication system 400 includes a node 402, a node 404, a node 406, and a node 408. The nodes 402, 404, and 406 may be similar to the nodes 102, 104, and 106 of FIG. 1, respectively. For the sake of simplicity, the details of the nodes 402, 404, and 406 are omitted here. Compared with FIG. 1, in FIG. 4, the node 404 (a destination node) receives paging information relayed from two relay nodes (the node 402 and the node 408). The node 402 receives paging information 410 from the network node 406, embeds the paging information in one or more data units 412, and transmits the one or more embedded data units to the node 404. In a separate process, the node 408 receives paging information 416 from the network node 406, embeds the paging information in one or more data units 414, and transmits the one or more embedded data units to the node 404. In this case, the node 404 may store paging information received from the different relay nodes (the nodes 402 and 408) and combine the paging information to increase reception reliability. For example, in some embodiments, the node 404 may combine the paging information received from the different nodes by accumulating a received signal energy of transmission of the one or more data units 412 and a received signal energy of transmission of the one or more data units 414. In some embodiments, the node 404 may combine the paging information received from the different nodes by selecting the most reliable paging information and discarding the least reliable information from the paging information 412 and the paging information 414. The node 404 may determine the most reliable paging information and the least reliable information based on comparison of SINR of the signals received from the two relay nodes.

In some embodiments, the node 402 and the node 408 may transmit the paging information in a cooperative manner. For example, in some embodiments, the node 402 and the node 408 may simultaneously send the one or more data units 412 and the one or more data units 414 to the node 404. In this case, the node 402 and the node 408 may be synchronized in time and/or frequency. In some embodiments, more than two relay nodes may transmit paging information in a cooperative manner.

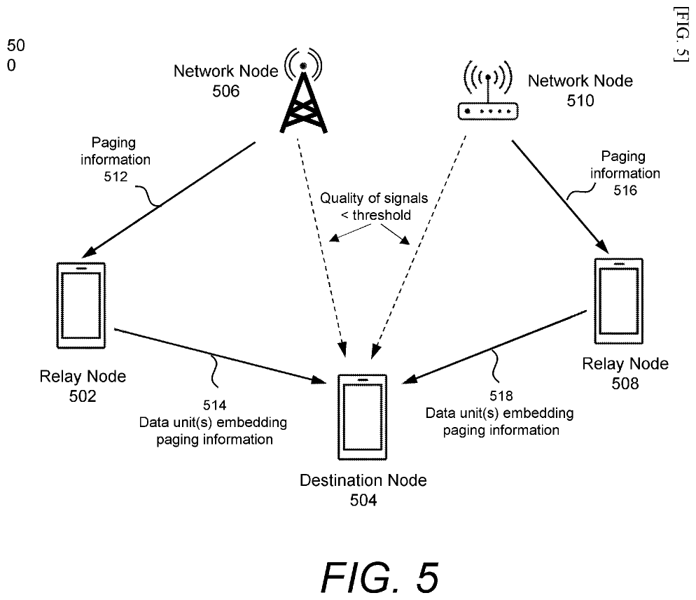

FIG. 5 is a schematic diagram illustrating a scheme for relaying paging information via a sidelink communication, consistent with some embodiments of the present disclosure. Referring to FIG. 5, a communication system includes a node 502, a node 504, a node 506, a node 508, and a node 510. The nodes 502, 504, 506, and 508 may be similar to the nodes 402, 404, 406, and 408 of FIG. 4, respectively. For the sake of simplicity, the details of the nodes 502, 504, 506, and 508 are omitted here. Compared with FIG. 4, in FIG. 5, the node 508 (a second relay node) receives paging information directed to the node 504 from a second network node 510, which is different from the network node 506. The node 502 receives paging information 512 from the network node 506, embeds the paging information in one or more data units 514, and transmits the one or more embedded data units to the node 504. In a separate process, the node 508 receives paging information 516 from the network node 510, embeds the paging information in one or more data units 518, and transmits the one or more embedded data units to the node 504. In this case, the node 504 may store paging information from the different relay nodes (the nodes 502 and 508) and combine the paging information from the different nodes to increase reception reliability. For example, in some embodiments, the node 504 may combine the paging information received from the different nodes by accumulating a received signal energy of transmission of the one or more data units 514 and a received signal energy of transmission of the one or more data units 518. In some embodiments, the node 504 may combine the paging information received from the different nodes by selecting the most reliable paging information and discarding the least reliable information from the paging information 512 and the paging information 516. The node 504 may determine the most reliable paging information and the least reliable information based on comparison of SINR of the signals received from the two relay nodes.

In some embodiments, the node 502 and the node 508 may transmit the paging information in a cooperative manner. For example, in some embodiments, the node 502 and the node 508 may simultaneously send the one or more data units 514 and the one or more data units 518 to the node 404. In this case, the node 502 and the node 508 may be synchronized in time and/or frequency. In some embodiments, more than two relay nodes may transmit paging information in a cooperative manner.

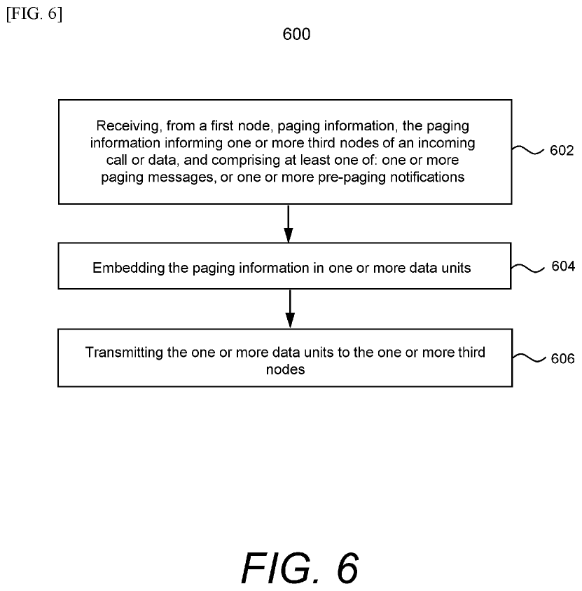

FIG. 6 is a schematic diagram illustrating a method 600 for a second node for relaying paging information in a communication, consistent with some embodiments of the present disclosure. The second node may be any relay node that receives paging information from a first node and relays the received paging information to one or more third nodes. For example, the second node may be the node 102 of FIG. 1, the node 202 of FIG. 2, the node 302 or the node 308 of FIG. 3, the node 402 or the node 408 of FIG. 4, or the node 502 or the node 508 of FIG. 5. The first node may include at least one of: one or more base stations, one or more core networks, one or more road-side units, one or more repeaters, one or more transponders, one or more wireless routers, one or more controllers, or one or more access points. For example, the first node may be the node 106 of FIG. 1, the node 206, the node 208, or the node 210 of FIG. 2, the node 306 or the node 302 of FIG. 3, the node 406 of FIG. 4, or the node 506 or the node 510 of FIG. 5.

Referring to FIG. 6, the method 600 includes a step 602 of receiving, from the first node, the paging information, the paging information informing one or more third nodes of an incoming call or data, and comprising at least one of: one or more paging messages, or one or more pre-paging notifications. The one or more third nodes may be one or more destination nodes or one or more relay nodes. Referring to examples of FIGS. 1-5, the third node may be the node 104 of FIG. 1, the node 204 of FIG. 2, the node 304 or the node 308 of FIG. 3, the node 404 of FIG. 4, or the node 504 of FIG. 5. For example, as shown in FIG. 1, the relay node 102 receives, from the network node 106, the paging information 108 directed to the destination node 104. The paging information 108 may include an ID of the destination node 104 so that the relay node 102 can have a knowledge that the paging information 108 is addressed to the node 104. For another example, as shown in FIG. 5, the relay node 502 receives, from the network node 506, the paging information 512 directed to the destination node 504, and the relay node 508 receives, from the network node 510, the paging information 516 directed to the destination node 504.

The method 600 includes a step 604 of embedding the paging information in one or more data units. The one or more data units may include at least one of: one or more application-level messages, one or more sidelink system information messages or blocks, one or more radio protocol data units, one or more radio protocol headers, one or more radio protocol control elements, physical layer control information, one or more physical layer fields, one or more synchronization frames, or one or more physical layer symbols. For example, in some embodiments, the one or more application-level messages may include at least one of: a V2X BSM, a DENM, or a CAM. The one or more application-level messages may include at least one of: a periodically generated application-level message or an event-triggered application-level message. The one or more radio protocol data units may include at least one of: one or more RLCs, one or more PDCPs, or one or more SDAPs. The one or more sidelink system information messages or blocks may include one or more sidelink master information blocks. The physical layer control information may include SCI.

The method 600 includes a step 606 of transmitting the one or more data units to the one or more third nodes. For example, as shown in FIG. 1, the relay node 102 transmits the one or more data units 110 that embeds the paging information 108 to the destination node 104. For another example, as shown in FIG. 3, the relay node 302 transmits the one or more data units 312 that embeds the paging information 310 to another relay node 308, and, as a further example shown in FIG. 3, the relay node 308 transmits the one or more data units 314 that embeds paging information to destination node 304.

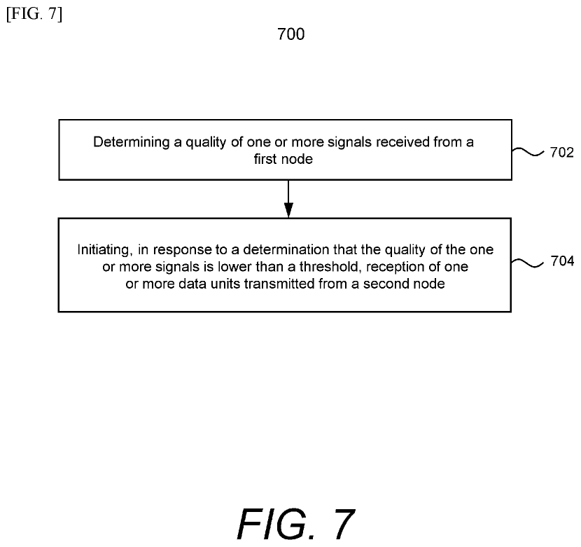

FIG. 7 is a schematic diagram illustrating a method 700 for a third node for receiving paging information in a communication, consistent with some embodiments of the present disclosure. The third node may be any destination node that receives relayed paging information from a relay node. For example, the third node may be the node 104 of FIG. 1, the node 204 of FIG. 2, the node 304 of FIG. 3, the node 404 of FIG. 4, or the node 504 of FIG. 5.

Referring to FIG. 7, the method 700 includes a step 702 of determining a quality of one or more signals received from a first node. The first node may include at least one of: one or more base stations, one or more core networks, one or more road-side units, one or more repeaters, one or more transponders, one or more wireless routers, one or more controllers, or one or more access points. As mentioned above, for example, the first node may be the node 106 of FIG. 1, the node 206, the node 208, or the node 210 of FIG. 2, the node 306 or the node 302 (e.g., in embodiments where the node 304 determines quality of signals received from node 302) of FIG. 3, the node 406 of FIG. 4, or the node 506 or the node 510 of FIG. 5. For example, as shown in FIG. 1, the node 104 (a destination node) determines the quality of one or more signals received from the network node 106. The quality of the one or more signals may include at least one of: an RSRP, an RSRQ, a SNR, or a SINR.

The method 700 includes a step 704 of initiating, in response to a determination that the quality of the one or more signals is lower than a threshold, reception of one or more data units transmitted from a second node. As mentioned above, for example, the second node may be the node 102 of FIG. 1, the node 202 of FIG. 2, the node 302 or the node 308 of FIG. 3, the node 402 or the node 408 of FIG. 4, or the node 502 or the node 508 of FIG. 5. For example, as shown in FIG. 1, in response to a determination that the quality of the one or more signals is lower than a threshold, the destination node 104 initiates reception of one or more data units from the relay node 102 via sidelink communication. The threshold may be configured by a first node (e.g., a network node) or pre-configured by the third node or predefined. The one or more data units transmitted from the second node includes embedded paging information that is originated from the first node and directed to the third node. For example, as shown in FIG. 1, the one or more data units 110 transmitted from the relay node 102 include embedded paging information 108 that is originated from the network node 106 and directed to the destination node 104. The paging information may include at least one of: one or more paging messages, or one or more pre-paging notifications. In some embodiments, the one or more data units are received from the relay node via one or more sidelink communications, as shown in FIGS. 1-5.

In some embodiments, the paging information is first paging information in a first paging occasion, and the method may further include: receiving second paging information in a second paging occasion, the second paging information being originated from a fourth node and relayed to the third node by a fifth node, and combining the first paging information and the second paging information. The second paging information may include at least one of: one or more second paging messages, or one or more second pre-paging notifications. In some embodiments, combining the first paging information and the second paging information may include accumulating a received signal energy of transmission of the first paging information and a received signal energy of transmission of the second paging information. In some embodiments, combining the first paging information and the second paging information may include selecting a most reliable paging information and discarding a least reliable information from the first paging information and the second paging information.

In some embodiments, the method 700 may further include storing the first paging information and the second paging information in a memory; and combining the stored first paging information and the stored second paging with paging information relayed to the third node in one or more subsequent paging occasions.

In some embodiments, the paging information is associated with at least one of: a hop counter, a first timestamp indicating a time when relayed paging information is received, a period during which the paging information is considered valid, a second timestamp indicating a time when the paging information becomes invalid, or a geographical position or a zone at which the paging information is generated. In some embodiments, the third node is a relay node, and the hop counter associated with the paging information is incremented in every hop where the paging information is relayed from the second node to the third node, and from the third node to another node.

The methods described in this disclosure can also be applied to a communication involving any number of relay nodes, any number of destination nodes, or any number of network nodes. For example, as shown in FIG. 2, a relay node 202 may receive paging information from multiple network nodes (the network nodes 206, 208, and 210), in which paging information is directed to the same destination node 204. For another example, as shown in FIG. 4, a network node 406 may transmit paging information directed to the same destination node (the node 404) to multiple relay nodes (the node 402 and 408). The methods described in this disclosure can also be applied to systems that comply with one or more standards other than 3GPP (e.g., the Institute of Electrical and Electronics Engineers (IEEE) standards), for example, IEEE 802.11 technologies.

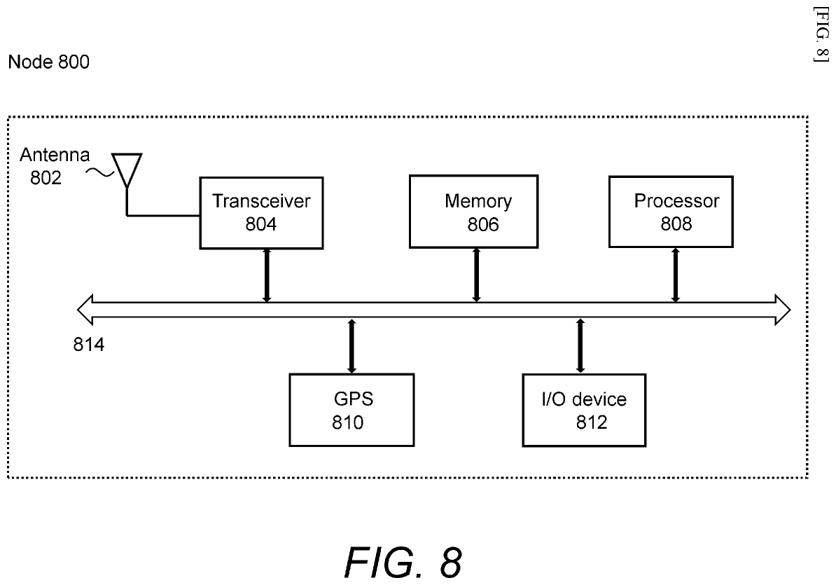

FIG. 8 is a block diagram of a node 800, consistent with some embodiments of the present disclosure. In some embodiments, the node 800 may be a relay node, such as the node 102 of FIG. 1, the node 202 of FIG. 2, the node 302 or the node 308 of FIG. 3, the node 402 or the node 408 of FIG. 4, or the node 502 or the node 508 of FIG. 5. In some embodiments, the node 800 may be a network node, such as the node 106 of FIG. 1, the node 206 or the node 208 or the node 210 of FIG. 2, the node 306 of FIG. 3, the node 406 of FIG. 4, or the node 506 or the node 510 of FIG. 5. In some embodiments, the node 800 may be a destination node, such as the node 104 of FIG. 1, the node 204 of FIG. 2, the node 304 of FIG. 3, the node 404 of FIG. 4, or the node 504 of FIG. 5. In some embodiments, the node 800 may be a node that performs the method 600 of FIG. 6. In some embodiments, the node 800 may be a node that performs the method 700 of FIG. 7. The node 800 may take any form, including but not limited to, a vehicle, a component mounted in a vehicle, a laptop computer, a wireless terminal including a mobile phone, a wireless handheld device, or wireless personal device, or any other form.

Referring to FIG. 8, the node 800 may include antenna 802 that may be used for transmission or reception of electromagnetic signals to/from one or more other nodes. The antenna 802 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 802 may include multiple (e.g., tens or hundreds) antenna elements and may enable multi-antenna functions such as beamforming. In some embodiments, the antenna 802 is a single antenna.

The node 800 may include a transceiver 804 that is coupled to the antenna 802. The transceiver 804 may be a wireless transceiver at the node 800 and may communicate bi-directionally with one or more other nodes. For example, the transceiver 804 may receive/transmit wireless signals from/to a base station via downlink/uplink communication. The transceiver 804 may also receive/transmit wireless signals from/to another node unit via sidelink communication. The transceiver 804 may include a modem to modulate the packets and provide the modulated packets to the antenna 802 for transmission, and to demodulate packets received from the antenna 802.

The node 800 may include a memory 806. The memory 806 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. The memory 806 may also be a cloud-based remote memory device. Combinations of the above examples are also within the scope of computer-readable medium.

The memory 806 may store information related to identities of node 800 and the signals and/or data received by antenna 802. The memory 806 may also store post-processing signals and/or data. The memory 806 may also store computer-readable program instructions, mathematical models, and algorithms that are used in signal processing in receiver 804 and computations in processor 808. The memory 906 may further store computer-readable program instructions for execution by processor 808 to operate the node 800 to perform various functions described in this disclosure. The memory may further store paging information received from a network node or relayed from a relay node. In some examples, the memory 806 may include a basic input/output system (BIOS) which may control basic hardware or software operation such as the interaction with peripheral components or devices.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The node 800 may include a processor 808 that may include a hardware device with processing capabilities. The processor 808 may include at least one of a general-purpose processor, a digital signal processor (DSP), a central processing unit (CPU), a graphical processing unit (GPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 808 may be implemented using a combination of devices (e.g., a combination of a DSP and a microprocessor, multiple microprocessors, one or more microprocessors in conjunction with a DSP core, or any other such configuration). The processor 808 may receive, from transceiver 804, downlink signals or sidelink signals and further process the signals. The processor 808 may also receive, from transceiver 804, data packets and further process the packets. In some embodiments, the processor 808 may be configured to operate a memory using a memory controller. In some embodiments, a memory controller may be integrated into the processor 808. The processor 808 may be configured to execute computer-readable instructions stored in a memory (e.g., the memory 806) to cause the node 800 to perform various functions.

The node 800 may include a global positioning system (GPS) 810. The GPS 810 may be used for enabling location-based services or other services based on a geographical position of the node 800 and/or synchronization among nodes. The GPS 810 may receive global navigation satellite systems (GNSS) signals from a single satellite or a plurality of satellite signals via the antenna 802 and provide a geographical position of the node 800 (e.g., coordinates of the node 800). In some embodiments, the GPS 810 is omitted. In some embodiments, a timer is included.

The node 800 may include an input/output (I/O) device 812 that may be used to communicate a result of signal processing and computation to a user or another device. The I/O device 812 may include a user interface including a display and an input device to transmit a user command to processor 808. The display may be configured to display a status of signal reception at the node 800, the data stored at memory 806, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The node 800 may further include a machine interface 814, such as an electrical bus that connects the transceiver 804, the memory 806, the processor 808, the GPS 810, and the I/O device 812.

In some embodiments, the node 800 may be a second node for relaying paging information in a communication. The processor 808 may be configured or programmed to execute the instructions stored in the memory 806 to receive, from a first node, the paging information, the paging information informing one or more third nodes of an incoming call or data, and including at least one of: one or more paging messages, or one or more pre-paging notifications; embed the paging information in one or more data units; and transmit the one or more data units to the one or more third nodes.

In some embodiments, the node 800 may be a third node for receiving paging information in a communication. The processor 808 may be configured or programmed to execute the instructions stored in the memory 806 to determine a quality of one or more signals received from a first node; and in response to a determination that the quality of the one or more signals is lower than a threshold, initiate reception of one or more data units transmitted from a second node. The one or more data units transmitted from the second node includes embedded paging information that is originated from the first node and directed to the third node, the paging information comprising at least one of: one or more paging messages, or one or more pre-paging notifications.

As used in this disclosure, use of the term “or” n a list of items indicates an inclusive list. The list of items may be prefaced by a phrase such as “at least one of” or “one or more of.” or example, a list of at least one of A, B, or C includes A or B or C or AB (i.e., A and B) or AC or BC or ABC (i.e., A and B and C). Also, as used in this disclosure, prefacing a list of conditions with the phrase “based on” hall not be construed as “based only on” he set of conditions and rather shall be construed as “based at least in part on” he set of conditions. For example, an outcome described as “based on condition A” ay be based on both a condition A and a condition B without departing from the scope of this disclosure.

In this specification, the terms “comprise,” “include,” or “contain” ay be used interchangeably and have the same meaning and are to be construed as inclusive and open-ended. The terms “comprise,” “include,” or “contain” ay be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” y reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” n various places in the present disclosure do not all necessarily refer to the same embodiment, nor are separate or alternative embodiments necessarily mutually exclusive of other embodiments.

Additionally, the articles “a” and “an” s used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” receded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1: A method for a second node for relaying paging information in a communication, the method comprising:
receiving, from a first node, the paging information, the paging information informing one or more third nodes of an incoming call or data, and comprising at least one of: one or more paging messages, or one or more pre-paging notifications;
embedding the paging information in one or more data units; and transmitting the one or more data units to the one or more third nodes.

Clause 2: The method of clause 1, wherein the one or more data units are transmitted to the one or more third nodes via one or more sidelink communications.

Clause 3: The method of clause 1, wherein the first node comprises at least one of: one or more base stations, one or more core networks, one or more road-side units, one or more repeaters, one or more transponders, one or more wireless routers, one or more controllers, or one or more access points.

Clause 4: The method of clause 1, wherein at least one of the one or more third nodes is a sidelink relay node configured to relay the one or more data units received from the second node to one or more other sidelink nodes.

Clause 5: The method of clause 1, wherein the paging information is first paging information in a first paging occasion, and the method further comprises:
receiving, from a fourth node, second paging information in a second paging occasion, the second paging information comprising at least one of: one or more second paging messages, or one or more second pre-paging notifications; and
combining the first paging information and the second paging information.

Clause 6: The method of clause 5, wherein combining the first paging information and the second paging information comprises:
accumulating a received signal energy of transmission of the first paging information and a received signal energy of transmission of the second paging information.

Clause 7: The method of clause 6, wherein the received signal energy of the transmission of the first paging information and the received signal energy of the transmission of the second paging information are accumulated by a soft combining.

Clause 8: The method of clause 5, wherein combining the first paging information and the second paging information comprises:
selecting a most reliable paging information and discarding a least reliable information from the first paging information and the second paging information.

Clause 9: The method of clause 1, further comprising:
storing the paging information in a memory; and
combining the stored paging information with paging information received in one or more subsequent paging occasions.

Clause 10: The method of clause 1, further comprising:
associating the paging information with at least one of: a hop counter, a first timestamp indicating a time when relayed paging information is received, a period during which the paging information is considered valid, a second timestamp indicating a time when the paging information becomes invalid, or a geographical position or a zone at which the paging information is generated.

Clause 11: The method of clause 10, wherein the hop counter associated with the paging information is incremented at every hop where paging information is relayed from one node to another node.

Clause 12: The method of clause 10, wherein, in one or more subsequent relay nodes after the second node, a time difference between the first timestamp and an internal clock time or an external time source time is determined, wherein, in response to a determination that the time difference exceeds a conveyed period, the paging information is discarded, and wherein the one or more subsequent relay nodes after the second node comprises the third node.

Clause 13: The method of clause 10, wherein, in one or more subsequent relay nodes after the second node, the second time stamp is compared with an internal clock time or an external time source time, wherein, in response to a determination that the second time stamp is equal to or greater than the internal clock time or the external time source time, the paging information is discarded, and wherein the one or more subsequent relay nodes after the second node comprises the third node.

Clause 14: The method of clause 10, wherein, in one or more subsequent relay nodes after the second node, a separation distance between the one or more subsequent relay nodes and the geographical position or the zone is calculated, wherein, in response to a determination that the separation distance is equal to or greater than a threshold, the paging information is discarded, and wherein the one or more subsequent relay nodes after the second node comprises the third node.

Clause 15: The method of clause 1, wherein the second node is a sidelink node, and the method further comprises:
sensing one or more sidelink radio resources to obtain information about activity of one or more other sidelink nodes; and
determining whether to transmit the one or more data units based on a sensing result.

Clause 16: The method of clause 15, wherein the one or more sidelink radio resources comprise at least one of a channel busy ratio or a received signal power.

Clause 17: The method of clause 15, further comprising:
transmitting the one or more data units to the one or more third nodes, in response to a determination that the sensing result indicates a higher activity and a channel busy ratio is smaller than a threshold value, or in response to a determination that the sensing result indicates lower activity and the channel busy ratio is greater than the threshold value.

Clause 18: The method of clause 15, further comprising:
determining not to transmit the one or more data units, in response to a determination that the sensing result indicates absence of other sidelink nodes in the proximity or an existence of a traffic congestion.

Clause 19: The method of clause 1, further comprising:
becoming, by the second node, a sidelink controlling node to control one or more other sidelink relay nodes, based on a determined probability of becoming the controlling node, wherein the probability of becoming the controlling node is determined based on at least one of: one or more radio measurements, a received paging signal energy, a node type, a vehicle type, a charging state of a vehicle, or a movement state of the vehicle.

Clause 20: The method of clause 19, wherein, based on the one or more radio measurements, a number of neighboring nodes is identified, and wherein the probability of becoming the controlling node increases as the number of identified neighboring nodes increases.

Clause 21: The method of clause 19, wherein the one or more radio measurements comprise at least one of: a received signal power or a channel busy radio.

Clause 22: The method of clause 19, wherein the probability of becoming the controlling node increases as the received paging signal energy increases.

Clause 23: The method of clause 19, wherein the node type comprises one of a vehicle, a vehicle mounted device, or a portable device, and wherein the vehicle or the vehicle mounted device has a higher probability of becoming the controlling node than the portable device.

Clause 24: The method of clause 19, wherein the second node is a vehicle or a device mounted in the vehicle, and the vehicle type comprises one of an electrical vehicle, an internal combustion engine vehicle, or a hybrid vehicle, and wherein the internal combustion engine vehicle or a device mounted in the internal combustion engine vehicle has a higher probability of becoming the controlling node than the electric vehicle or a device mounted in the electrical vehicle, and the electric vehicle or the device mounted in the electrical vehicle has a higher probability of becoming the controlling node than the hybrid vehicle or a device mounted in the hybrid vehicle.

Clause 25: The method of clause 19, wherein the second node is a vehicle or a device mounted in the vehicle, and wherein a charged vehicle or a device mounted in the charged vehicle has a higher probability of becoming the controlling node than a vehicle in a process of charging or a device mounted in the vehicle in the process of charging, and a vehicle in higher state of charge or a device mounted in the vehicle in higher state of charge has a higher probability of becoming the controlling node than a vehicle in lower state of charge or a device mounted in the vehicle in lower state of charge.

Clause 26: The method of clause 19, wherein the second node is a vehicle or a device mounted in the vehicle, and wherein a moving vehicle or a device mounted in the moving vehicle has a higher probability of becoming the controlling node than a parked vehicle or a device mounted in the parked vehicle.

Clause 27: The method of clause 1, wherein the second node comprises a plurality of relay nodes configured to transmit the paging information in a cooperative manner, and the plurality of relay nodes are synchronized in at least one of time or frequency.

Clause 28: The method of clause 1, wherein the second node is a device mounted in a vehicle, and the third node comprises one or more portable devices disposed inside the vehicle, and the paging information includes an identification (ID) of at least one destination node, and the method further comprises:
receiving, via the one or more portable devices, an ID of at least one of the one or more portable devices;
comparing the ID included in the paging information and the ID of the at least one of the one or more portable devices; and
transmitting the one or more data units to the at least one of the one or more portable devices, in response to a determination that the ID included in the paging information matches with the ID of the at least one of the one or more portable devices.

Clause 29: The method of clause 1, wherein the one or more data units comprise at least one of: one or more application-level messages, one or more sidelink system information messages or blocks, one or more radio protocol data units, one or more radio protocol headers, one or more radio protocol control elements, physical layer control information, one or more physical layer fields, one or more synchronization frames, or one or more physical layer symbols.

Clause 30: The method of clause 29, wherein the one or more application-level messages comprise at least one of: a periodically generated application-level message or an event-triggered application-level message.

Clause 31: The method of clause 29, wherein the one or more application-level messages comprise at least one of: a vehicle-to-everything (V2X) basic safety message (BSM), a decentralized environmental notification message (DENM), or a cooperative awareness message (CAM).

Clause 32: The method of clause 29, wherein the one or more sidelink system information messages or blocks comprise one or more sidelink master information blocks.

Clause 33: The method of clause 29, wherein the one or more radio protocol data units comprise at least one of: one or more radio link controls (RLCs), one or more packet data convergence protocols (PDCPs), or one or more service data adaptation protocols (SDAPs).

Clause 34: The method of clause 29, wherein the one or more radio protocol control elements comprise one or more medium access control (MAC) protocol control elements (CEs).

Clause 35: The method of clause 29, wherein the physical layer control information comprises sidelink control information (SCI).

Clause 36: The method of clause 1, wherein the one or more data units comprise one or more first type data units and one or more second type data units, the paging information comprises one or more paging messages, and one or more pre-paging notifications, and wherein the one or more paging messages are embedded in the one or more first type data units, and the one or more pre-paging notifications are embedded in the one or more second type data units.

Clause 37: A method for a third node for receiving paging information in a communication, the method comprising:
determining a quality of one or more signals received from a first node; and
in response to a determination that the quality of the one or more signals is lower than a threshold, initiating reception of one or more data units transmitted from a second node, wherein the one or more data units transmitted from the second node includes embedded paging information that is originated from the first node and directed to the third node, the paging information comprising at least one of: one or more paging messages, or one or more pre-paging notifications.

Clause 38: The method of clause 37, wherein initiating the reception of the one or more data units further comprises:
receiving, from the second node, the one or more data units via one or more sidelink communications.

Clause 39: The method of clause 37, wherein the quality of the one or more signals comprises at least one of: a reference signal received power (RSRP), a reference signal received quality (RSRQ), signal to noise ratio (SNR), or a signal to interreference-plus noise ratio (SINR).

Clause 40: The method of clause 37, wherein the first node comprises at least one of: one or more base stations, one or more core networks, one or more road-side units, one or more repeaters, one or more transponders, one or more wireless routers, one or more controllers, or one or more access points.

Clause 41: The method of clause 37, wherein the threshold is configured by the first node or pre-configured at the third node.

Clause 42: The method of clause 37, wherein initiating the reception of the one or more data units further comprises:
starting a first timer, in response to a determination that the quality of the one or more signals is lower than the threshold;
starting a second timer, in response to a determination that the first timer is running upon a paging occasion; and
initiating the reception of the one or more data units transmitted from the second node, in response to a determination that the second timer is running.

Clause 43: The method of clause 42, further comprising: resetting the first timer and the second timer to zero, in response to identification of the paging.

Clause 44: The method of clause 42, wherein the paging occasion is a first paging occasion, and the method further comprises:
waiting for a second paging occasion, in response to a determination that the second timer expires.

Clause 45: The method of clause 37, wherein the paging information is first paging information in a first paging occasion, and the method further comprises:
receiving second paging information in a second paging occasion, the second paging information being originated from a fourth node and relayed to the third node by a fifth node, the second paging information comprising at least one of: one or more second paging messages, or one or more second pre-paging notifications; and
combining the first paging information and the second paging information.

Clause 46: The method of clause 45, wherein combining the first paging information and the second paging information comprises:
accumulating a received signal energy of transmission of the first paging information and a received signal energy of transmission of the second paging information.

Clause 47: The method of clause 45, wherein combining the first paging information and the second paging information comprises:
selecting a most reliable paging information and discarding a least reliable information from the first paging information and the second paging information.

Clause 48: The method of clause 45, further comprising:
storing the first paging information and the second paging information in a memory; and
combining the stored first paging information and the stored second paging with paging information relayed to the third node in one or more subsequent paging occasions.

Clause 49: The method of clause 37, wherein the paging information is associated with at least one of: a hop counter, a first timestamp indicating a time when relayed paging information is received, a period during which the paging information is considered valid, a second timestamp indicating a time when the paging information becomes invalid, or a geographical position or a zone at which the paging information is generated.

Clause 50: The method of clause 49, wherein the third node is a relay node, and the hop counter associated with the paging information is incremented in every hop where the paging information is relayed from the second node to the third node, and from the third node to another node.

Clause 51: The method of clause 49, further comprising:
determining a time difference between the first timestamp and an internal clock time or an external time source time; and
in response to a determination that the time difference exceeds a conveyed period, discarding the paging information.

Clause 52: The method of clause 49, further comprising:
comparing the second time stamp with an internal clock time or an external time source time; and
in response to a determination that the second time stamp is equal to or greater than the internal clock time or the external time source time, discarding the paging information.

Clause 53: The method of clause 49, further comprising:
calculating a separation distance between the third node and the geographical position or the zone; and
in response to a determination that the distance is equal to or greater than a threshold, discarding the paging information.

Clause 54: A second node for relaying paging information in a communication, the second node comprising:
a memory storing an instruction; and
a processor configured to execute the instruction stored in the memory to:
receive, from a first node, the paging information, the paging information informing one or more third nodes of an incoming call or data, and comprising at least one of: one or more paging messages, or one or more pre-paging notifications;
embed the paging information in one or more data units; and
transmit the one or more data units to the one or more third nodes.

Clause 55: The second node of clause 54, wherein the one or more data units are transmitted to the one or more third nodes via one or more sidelink communications.

Clause 56: The second node of clause 54, wherein the first node comprises at least one of:
one or more base stations, one or more core networks, one or more road-side units, one or more repeaters, one or more transponders, one or more wireless routers, one or more controllers, or one or more access points.

Clause 57: The second node of clause 54, wherein at least one of the one or more third nodes is a sidelink relay node configured to relay the one or more data units received from the second node to one or more other sidelink nodes.

Clause 58: The second node of clause 54, wherein the paging information is first paging information in a first paging occasion, and the processor is further configured to execute the instruction stored in the memory to:
receive, from a fourth node, second paging information in a second paging occasion, the second paging information comprising at least one of: one or more second paging messages, or one or more second pre-paging notifications; and
combine the first paging information and the second paging information.

Clause 59: The second node of clause 58, wherein the processor is further configured to execute the instruction stored in the memory to: accumulate a received signal energy of transmission of the first paging information and a received signal energy of transmission of the second paging information.

Clause 60: The second node of clause 59, wherein the received signal energy of the transmission of the first paging information and the received signal energy of the transmission of the second paging information are accumulated by a soft combining.

Clause 61: The second node of clause 58, wherein the processor is further configured to execute the instruction stored in the memory to:
select a most reliable paging information and discarding a least reliable information from the first paging information and the second paging information.

Clause 62: The second node of clause 54, wherein the processor is further configured to execute the instruction stored in the memory to:
store the paging information in a memory; and
combine the stored paging information with paging information received in one or more subsequent paging occasions.

Clause 63: The second node of clause 54, wherein the processor is further configured to execute the instruction stored in the memory to:
associate the paging information with at least one of: a hop counter, a first timestamp indicating a time when relayed paging information is received, a period during which the paging information is considered valid, a second timestamp indicating a time when the paging information becomes invalid, or a geographical position or a zone at which the paging information is generated.

Clause 64: The second node of clause 63, wherein the hop counter associated with the paging information is incremented at every hop where paging information is relayed from one node to another node.

Clause 65: The second node of clause 63, wherein, in one or more subsequent relay nodes after the second node, a time difference between the first timestamp and an internal clock time or an external time source time is determined, wherein, in response to a determination that the time difference exceeds a conveyed period, the paging information is discarded, and wherein the one or more subsequent relay nodes after the second node comprises the third node.

Clause 66: The second node of clause 63, wherein, in one or more subsequent relay nodes after the second node, the second time stamp is compared with an internal clock time or an external time source time, wherein, in response to a determination that the second time stamp is equal to or greater than the internal clock time or the external time source time, the paging information is discarded, and wherein the one or more subsequent relay nodes after the second node comprises the third node.

Clause 67: The second node of clause 63, wherein, in one or more subsequent relay nodes after the second node, a separation distance between the one or more subsequent relay nodes and the geographical position or the zone is calculated, wherein, in response to a determination that the separation distance is equal to or greater than a threshold, the paging information is discarded, and wherein the one or more subsequent relay nodes after the second node comprises the third node.

Clause 68: The second node of clause 54, wherein the second node is a sidelink node, and the processor is further configured to execute the instruction stored in the memory to:
sense one or more sidelink radio resources to obtain information about activity of one or more other sidelink nodes; and
determine whether to transmit the one or more data units based on a sensing result.

Clause 69: The second node of clause 68, wherein the one or more sidelink radio resources comprise at least one of a channel busy ratio or a received signal power.

Clause 70: The second node of clause 68, wherein the processor is further configured to execute the instruction stored in the memory to:
transmit the one or more data units to the one or more third nodes, in response to a determination that the sensing result indicates a higher activity and a channel busy ratio is smaller than a threshold value, or in response to a determination that the sensing result indicates lower activity and the channel busy ratio is greater than the threshold value.

Clause 71: The second node of clause 68, wherein the processor is further configured to execute the instruction stored in the memory to:
determine not to transmit the one or more data units, in response to a determination that the sensing result indicates absence of other sidelink nodes in the proximity or an existence of a traffic congestion.

Clause 72: The second node of clause 54, wherein the processor is further configured to execute the instruction stored in the memory to:
become, by the second node, a sidelink controlling node to control one or more other sidelink relay nodes, based on a determined probability of becoming the controlling node, wherein the probability of becoming the controlling node is determined based on at least one of: one or more radio measurements, a received paging signal energy, a node type, a vehicle type, a charging state of a vehicle, or a movement state of the vehicle.

Clause 73: The second node of clause 72, wherein, based on the one or more radio measurements, a number of neighboring nodes is identified, and wherein the probability of becoming the controlling node increases as the number of identified neighboring nodes increases.

Clause 74: The second node of clause 72, wherein the one or more radio measurements comprise at least one of: a received signal power or a channel busy radio.

Clause 75: The second node of clause 72, wherein the probability of becoming the controlling node increases as the received paging signal energy increases.

Clause 76: The second node of clause 72, wherein the node type comprises one of a vehicle, a vehicle mounted device, or a portable device, and wherein the vehicle or the vehicle mounted device has a higher probability of becoming the controlling node than the portable device.

Clause 77: The second node of clause 72, wherein the second node is a vehicle or a device mounted in the vehicle, and the vehicle type comprises one of an electrical vehicle, an internal combustion engine vehicle, or a hybrid vehicle, and wherein the internal combustion engine vehicle or a device mounted in the internal combustion engine vehicle has a higher probability of becoming the controlling node than the electric vehicle or a device mounted in the electrical vehicle, and the electric vehicle or the device mounted in the electrical vehicle has a higher probability of becoming the controlling node than the hybrid vehicle or a device mounted in the hybrid vehicle.

Clause 78: The second node of clause 72, wherein the second node is a vehicle or a device mounted in the vehicle, and wherein a charged vehicle or a device mounted in the charged vehicle has a higher probability of becoming the controlling node than a vehicle in a process of charging or a device mounted in the vehicle in the process of charging, and a vehicle in high state of charge or a device mounted in the vehicle in high state of charge has a higher probability of becoming the controlling node than a vehicle in low state of charge or a device mounted in the vehicle in low state of charge.

Clause 79: The second node of clause 72, wherein the second node is a vehicle or a device mounted in the vehicle, and wherein a moving vehicle or a device mounted in the moving vehicle has a higher probability of becoming the controlling node than a parked vehicle or a device mounted in the parked vehicle.

Clause 80: The second node of clause 54, wherein the second node comprises a plurality of relay nodes configured to transmit the paging information in a cooperative manner, and the plurality of relay nodes are synchronized in at least one of time or frequency.

Clause 81: The second node of clause 54, wherein the second node is a device mounted in a vehicle, and the third node comprises one or more portable devices disposed inside the vehicle, and the paging information includes an identification (ID) of at least one destination node, and the processor is further configured to execute the instruction stored in the memory to:
receive, via the one or more portable devices, an ID of at least one of the one or more portable devices;
compare the ID included in the paging information and the ID of the at least one of the one or more portable devices; and
transmit the one or more data units to the at least one of the one or more portable devices, in response to a determination that the ID included in the paging information matches with the ID of the at least one of the one or more portable devices.

Clause 82: The second node of clause 54, wherein the one or more data units comprise at least one of: one or more application-level messages, one or more sidelink system information messages or blocks, one or more radio protocol data units, one or more radio protocol headers, one or more radio protocol control elements, physical layer control information, one or more physical layer fields, one or more synchronization frames, or one or more physical layer symbols.

Clause 83: The second node of clause 82, wherein the one or more application-level messages comprise at least one of: a periodically generated application-level message or an event-triggered application-level message.

Clause 84: The second node of clause 82, wherein the one or more application-level messages comprise at least one of: a vehicle-to-everything (V2X) basic safety message (BSM), a decentralized environmental notification message (DENM), or a cooperative awareness Message (cam).

Clause 85: The second node of clause 82, wherein the one or more sidelink system information messages or blocks comprise one or more sidelink master information blocks.

Clause 86: The second node of clause 82, wherein the one or more radio protocol data units comprise at least one of: one or more radio link controls (RLCs), one or more packet data convergence protocols (PDCPs), or one or more service data adaptation protocols (SDAPs).

Clause 87: The second node of clause 82, wherein the one or more radio protocol control elements comprise one or more medium access control (MAC) protocol control elements (CEs).

Clause 88: The second node of clause 82, wherein the physical layer control information comprises sidelink control information (SCI).

Clause 89: The second node of clause 54, wherein the one or more data units comprise one or more first type data units and one or more second type data units, the paging information comprises one or more paging messages, and one or more pre-paging notifications, and
wherein the one or more paging messages are embedded in the one or more first type data units, and the one or more pre-paging notifications are embedded in the one or more second type data units.

Clause 90: A third node for receiving paging information in a communication, the third node comprising:
a memory storing an instruction; and
a processor configured to execute the instruction stored in the memory to:
determine a quality of one or more signals received from a first node; and
in response to a determination that the quality of the one or more signals is lower than a threshold, initiate reception of one or more data units transmitted from a second node, wherein the one or more data units transmitted from the second node includes embedded paging information that is originated from the first node and directed to the third node, the paging information comprising at least one of: one or more paging messages, or one or more pre-paging notifications.

Clause 91: The third node of clause 90, wherein processor is configured to execute the instruction stored in the memory to:
receive, from the second node, the one or more data units via one or more sidelink communications.

Clause 92: The third node of clause 90, wherein the quality of the one or more signals comprises at least one of: a reference signal received power (RSRP), a reference signal received quality (RSRQ), signal to noise ratio (SNR), or a signal to interreference-plus noise ratio (SINR).

Clause 93: The third node of clause 90, wherein the first node comprises at least one of: one or more base stations, one or more core networks, one or more road-side units, one or more repeaters, one or more transponders, one or more wireless routers, one or more controllers, or one or more access points.

Clause 94: The third node of clause 90, wherein the threshold is configured by the first node or pre-configured at the third node.

Clause 95: The third node of clause 90, wherein the processor is configured to execute the instruction stored in the memory to:
start a first timer, in response to a determination that the quality of the one or more signals is lower than the threshold;
start a second timer, in response to a determination that the first timer is running upon a paging occasion; and
initiate the reception of the one or more data units transmitted from the second node, in response to a determination that the second timer is running.

Clause 96: The third node of clause 95, wherein the processor is configured to execute the instruction stored in the memory to:
reset the first timer and the second timer to zero, in response to identification of the paging.

Clause 97: The third node of clause 95, wherein the paging occasion is a first paging occasion, and the processor is configured to execute the instruction stored in the memory to:
wait for a second paging occasion, in response to a determination that the second timer expires.

Clause 98: The third node of clause 90, wherein the paging information is first paging information in a first paging occasion, and the processor is configured to execute the instruction stored in the memory to:
receive second paging information in a second paging occasion, the second paging information being originated from a fourth node and relayed to the third node by a fifth node, the second paging information comprising at least one of: one or more second paging messages, or one or more second pre-paging notifications; and
combine the first paging information and the second paging information.

Clause 99: The third node of clause 98, wherein the processor is configured to execute the instruction stored in the memory to:
accumulate a received signal energy of transmission of the first paging information and a received signal energy of transmission of the second paging information.

Clause 100: The third node of clause 98, wherein the processor is configured to execute the instruction stored in the memory to:
select a most reliable paging information and discarding a least reliable information from the first paging information and the second paging information.

Clause 101: The third node of clause 98, wherein the processor is configured to execute the instruction stored in the memory to:
store the first paging information and the second paging information in a memory; and combine the stored first paging information and the stored second paging with paging information relayed to the third node in one or more subsequent paging occasions.

Clause 102: The third node of clause 90, wherein the paging information is associated with at least one of: a hop counter, a first timestamp indicating a time when relayed paging information is received, a period during which the paging information is considered valid, a second timestamp indicating a time when the paging information becomes invalid, or a geographical position or a zone at which the paging information is generated.

Clause 103: The third node of clause 102, wherein the third node is a relay node, and the hop counter associated with the paging information is incremented in every hop where the paging information is relayed from the second node to the third node, and from the third node to another node.

Clause 104: The third node of clause 102, wherein the processor is configured to execute the instruction stored in the memory to:
determine a time difference between the first timestamp and an internal clock time or an external time source time; and
in response to a determination that the time difference exceeds a conveyed period, discard the paging information.

Clause 105: The third node of clause 102, wherein the processor is configured to execute the instruction stored in the memory to:
compare the second time stamp with an internal clock time or an external time source time; and
in response to a determination that the second time stamp is equal to or greater than the internal clock time or the external time source time, discard the paging information.

Clause 106: The third node of clause 102, wherein the processor is configured to execute the instruction stored in the memory to:
calculate a separation distance between the third node and the geographical position or the zone; and
in response to a determination that the distance is equal to or greater than a threshold, discard the paging information.

Clause 107: A non-transitory computer-readable medium storing instructions that are executable by one or more processors of a second node for relaying paging information, to perform a method, the method comprising:
receiving, from a first node, the paging information, the paging information informing one or more third nodes of an incoming call or data, and comprising at least one of: one or more paging messages, or one or more pre-paging notifications;
embedding the paging information in one or more data units; and
transmitting the one or more data units to the one or more third nodes.

Clause 108: A non-transitory computer-readable medium storing instructions that are executable by one or more processors of a third node for receiving paging information, to perform a method, the method comprising:
determining a quality of one or more signals received from a first node; and
in response to a determination that the quality of the one or more signals is lower than a threshold, initiating reception of one or more data units transmitted from a second node, wherein the one or more data units transmitted from the second node includes embedded paging information that is originated from the first node and directed to the third node, the paging information comprising at least one of: one or more paging messages, or one or more pre-paging notifications.

What is claimed is:

1. A method for a first user equipment (UE) relaying paging information from a second UE to a third UE, comprising:
receiving, from a base station, paging information for the third UE.

2. The method of claim 1, further comprising:
sensing one or more sidelink radio resources to obtain information about activity of one or more other sidelink nodes; and
determining whether to transmit the data unit based on a sensing result.

3. The method of claim 1, further comprising:
receiving an identification (ID) of the second UE;
comparing the ID included in the first paging information or the second paging information; and
transmitting the data unit in response to a determination that the ID included in the first paging information or the second paging information matches with the ID of the second UE.

4. A first user equipment (UE) relaying paging information from a second UE to a third UE, comprising:
a receiver configured to receive, from a base station, paging information for the third UE.
